(19) United States
(12) Patent Application Publication
(10) Pub. No.: US 2002/0089152 A1
(43) Pub. Date: Jul. 11, 2002

(54) Dual plane head protection air bag system

(76) Inventors: Bassam Georges Khoudari, Sterling Heights, MI (US); Lawrence A. Firlik, Farmington Hills, MI (US); Gregg G. Anderson, Saint Clair Shores, MI (US)

Correspondence Address: KATHRYN A. MARRA, DELPHI TECHNOLOGIES, INC., Legal Staff, Mail Code: 480-414-420, P.O.Box 5052, Troy, MI, 48007-5052, US

(21) Appl. No.: 09/757,298

(22) Filed: Jan. 9, 2001

(51) Int. Cl. B60R 21/28; B60R 21/16

(52) U.S. Cl. 280/728.2; 280/741

(57) ABSTRACT

An inflatable air bag cushion for impact protection across a forward portion of a vehicle framework. The air bag cushion includes a first inflatable chamber of substantially wedge-shaped geometry deployable from a storage position along the “A” pillar of a vehicle in a plane substantially parallel to the side of the vehicle and a second inflatable chamber in fluid communication with the first inflatable chamber deployable in covering relation over the forward roof rail extending toward the occupant to be protected in a plane intersecting the plane of coverage established by the first inflatable chamber.

### TECHNICAL FIELD

This invention relates to an inflatable air bag for use in the protection of an occupant within a transportation vehicle, and more particularly to an inflatable air bag for disposition in covering relation to surfaces of a transportation vehicle extending in intersecting planes in front of an occupant to be protected.

### BACKGROUND OF THE INVENTION

The use of air bag assemblies including inflatable cushion elements for protecting the occupants of a vehicle during a collision event is generally known. Such air bag assemblies are typically located at locations within the interior of the vehicle so as to permit deployment of the cushion between a vehicle occupant and opposing surface structures which may be contacted by the vehicle occupant during a collision event. Known air bag assemblies include assemblies mounted within the steering wheel for protection of the operator of the vehicle, assemblies mounted within the dash panel in opposing relation to a vehicle passenger, assemblies mounted adjacent the seats of the vehicle for side protection of the occupants, and curtain structures mounted along the roof line for deployment over the side portions of the vehicle interior during a roll-over event.

Regardless of the orientation of the air bag assembly within the vehicle, activation of the air bag system is typically initiated by a signal received from one or more sensors measuring vehicle conditions such as deceleration exceeding a certain predetermined value. Upon the receipt of an initiating signal, a gas generating inflator discharges a volume of inflation gas into an air bag cushion thereby causing the air bag cushion to rapidly inflate and exit a confined storage region in which the air bag cushion is housed. As the air bag cushion becomes free of its stored confinement, further expansion takes place until full inflation occurs. Upon the achievement of full inflation, the air bag cushion is disposed between an occupant to be protected and an interior surface against which the occupant may come into contact during the collision event.

Typical prior art air bag cushions have generally been deployed across surfaces disposed in a single plane. That is, it is believed that individual prior air bag cushions have not generally extended across regions of the vehicle interior which define intersecting planar surfaces. Rather, such intersecting planar surfaces have typically been covered by separate discrete air bag cushions.

Aside form providing cushioning coverage over the steering column and instrument panel of the vehicle, it is believed that in some instances it may be beneficial to provide coverage by inflatable air bag cushions over portions of the structural framework of the vehicle due to the fact that such structures tend to substantially resist deformation and corresponding energy dissipation upon impact by an occupant. Accordingly, it has been proposed to use extended curtain structures and bolster cushions for deployment along portions of the framework. However, such arrangements typically require extensive hidden storage volumes along the roof line of the vehicle. Such structures have thus proven difficult to utilize within automotive vehicles with retractable roof structures (i.e. convertible-type automobiles). Such difficulty arises due to the absence of substantial confined storage space in which air bag cushions and corresponding inflators may be stored.

### SUMMARY OF THE INVENTION

The present invention provides advantages and alternatives over the prior art by providing an air bag cushioning system which utilizes a single inflatable cushion activatable by a single inflator to cover both the forward pillar element adjacent to a front seated vehicle occupant (i.e. the “A” pillar) as well as at least a portion of the forward roof rail structure extending above the windshield in front of a front seated vehicle occupant. Such coverage may be effected without requiring excessive storage capacity thereby facilitating the use of the air bag system within convertible-type automobiles.

These advantages may be realized in a potentially preferred form of the invention by providing an inflatable air bag cushion including a first inflatable chamber of substantially wedge-shaped geometry deployable from a storage position along the “A” pillar of a vehicle in a plane substantially parallel to the side of the vehicle. The inflatable air bag cushion preferably includes a second inflatable chamber in fluid communication with the first inflatable chamber. The second chamber is deployable in covering relation to the forward roof rail in covering relation to a plane intersecting the plane of coverage established by the first inflatable chamber.

In accordance with a potentially preferred aspect of the present invention, both the first inflatable chamber and the second inflatable chamber of the inflatable air bag cushion may be inflated by gas emitted from a single inflator.

In accordance with another potentially preferred aspect of the present invention, the air bag cushion may be constructed from a textile fabric material of either coated or uncoated character. Such textile material may be enclosed by seams disposed substantially entirely across surfaces which do not contact a vehicle occupant upon deployment of the air bag cushion.

Additional advantageous aspects of the invention will be set forth in part in the description which follows and in part will be obvious from the description or may be learned by practice of the invention. While the invention is illustrated and will be described in connection with a potentially preferred embodiment, it is to be understood that both the forgoing general description and the following detailed description are exemplary and explanatory only and are not to be construed as restrictive of the invention in any way. On the contrary, it is the intent of the applicants to cover all alternatives, modifications, and equivalents as may be included within the true spirit and scope of the inventive principles set forth herein.

### BRIEF DESCRIPTION OF THE DRAWINGS

The accompanying drawings which are incorporated in and which constitute a part of this specification illustrate several potentially preferred embodiments of the present invention and, together with the general description of the invention given above and the detailed description set forth below, serve to explain the principles of the invention in illustrative and exemplary fashion wherein:

FIG. 1 is a perspective view of the interior of a transportation vehicle;

FIG. 2 is an elevation plan view of an inflatable air bag cushion useful in the air bag system according to the present invention and illustrating phantom fold lines across the surface of the air bag cushion;

FIG. 3 is a view of the air bag cushion in FIG. 2 following application of folds along the illustrated fold lines;

FIG. 4 is a view similar to FIG. 3 upon the introduction of an additional fold; and

FIG. 5 is a view similar to FIG. 1 illustrating the air bag cushion of FIGS. 2-4 in an inflated, fully deployed state.

### DESCRIPTION OF THE PREFERRED EMBODIMENT

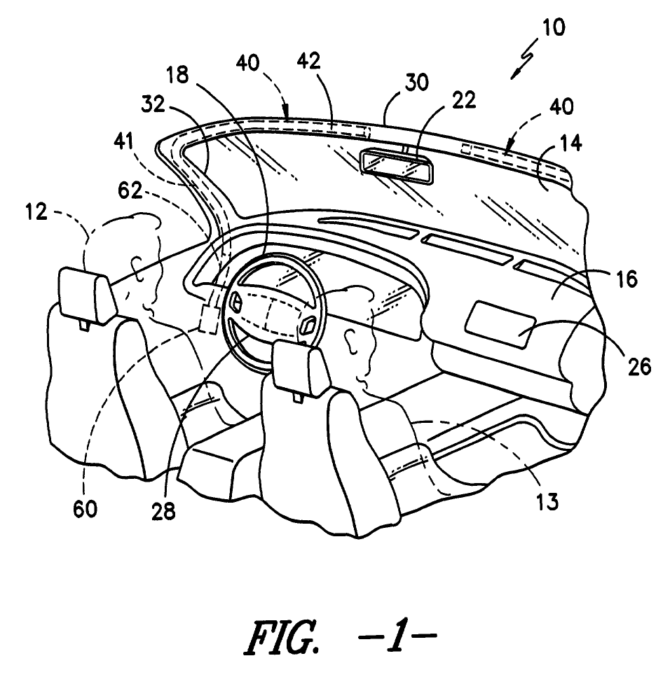

Turning now to the figures, one potentially preferred embodiment of an air bag system according to the present invention is illustrated. As will be appreciated, to the extent possible, like elements have been designated by like reference numerals throughout the various views. In FIG. 1 there is illustrated a vehicle 10 such as a convertible-type automobile for the transportation of an operator 12 and one or more passengers 13. The vehicle 10 includes a windshield 14, an instrument panel 16, and a steering wheel 18. A rear view mirror 22 is preferably provided to afford the operator 12 with a view directly rearward of the vehicle 10. The instrument panel 16 and the steering wheel 18 may include air bag assemblies 26, 28 respectively disposed beneath cover elements as shown.

As illustrated, the windshield 14 is preferably housed within a structural framework including a forward roof rail 30 which is disposed in substantially opposing relation to the vehicle operator 12 and passenger 13. The structural framework also preferably includes a laterally disposed forward pillar element 32 which provides structural support along the lateral edge of the windshield 14. As will be appreciated, while only a single forward pillar element 32 is illustrated in angled relation forward of the operator 12, a corresponding forward pillar element is likewise disposed in angled relation forward of the vehicle passenger 13. As will be appreciated by those of skill in the art, both the forward roof rail 30 and the forward pillar element 32 are typically formed of a substantially rigid material such as structural steel or the like which is covered by decorative trim of plastic or the like.

As previously indicated, in some instances, it may be desirable to provide a degree of cushioning between the occupants of the vehicle 10 and the forward roof rail 30 and pillar element 32. According to a potentially preferred form of the present invention, such coverage may be provided by an inflatable air bag cushion 40 which is stored in substantially hidden relation along portions of the forward roof rail 30 and pillar element 32 beneath the covering trim. As shown, the inflatable air bag cushion 40 is preferably in fluid communication with an inflator 60 mounted in hidden relation at a position beneath the instrument panel 16. Inflation gas is transmitted from the inflator 60 into the air bag cushion 40 by an appropriate conduit such as a hose element 62 or the like.

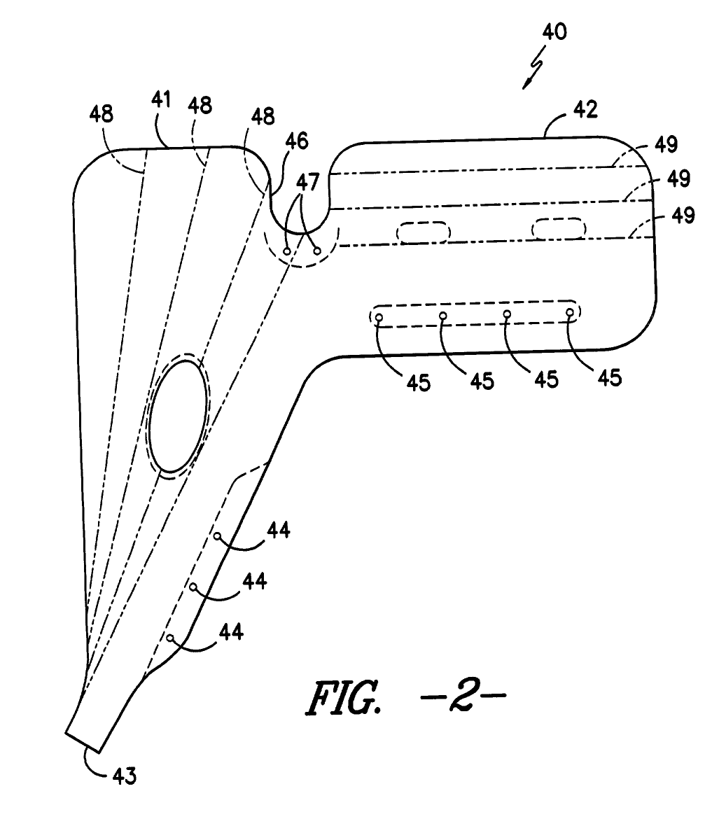

One potentially preferred configuration for the air bag cushion 40 is illustrated in FIG. 2. According to the illustrated and potentially preferred embodiment, the air bag cushion 40 includes a first inflatable chamber 41 of substantially wedge shaped configuration. The air bag cushion 40 preferably further includes a second inflatable chamber 42 of substantially elongate rectangular configuration extending to the side of the first inflatable chamber 41. The first inflatable chamber 41 preferably extends in narrowing relation away from the second inflatable chamber 42 at a substantially obtuse angle.

As shown, the first inflatable chamber 41 and the second inflatable chamber 42 are in fluid communication with one another. As will be appreciated, such fluid communication permits inflation gas expelled from the inflator 60 to enter a mouth opening 43 at the apex of the first inflatable chamber 41 and thereafter to be used to inflate both the first inflatable chamber 41 as well as the second inflatable chamber 42.

The air bag cushion 40 is preferably formed by seaming together panels of substantially pliable material such as woven, knitted or nonwoven textile fabric or the like. Woven constructions of nylon yam may be particularly preferred. It is contemplated that such materials may be used either in their natural state or may be coated with a permeability blocking coating if desired. By way of example only and not limitation, such permeability blocking coatings may include silicone, neoprene rubber, acrylics, polyurethane compositions and polyamide dispersions.

The air bag cushion 40 may be assembled by joining techniques including industrial sewing, ultrasonic welding, R. F. welding or combinations thereof. It is also contemplated that the air bag cushion 40 may be manufactured utilizing formation techniques such as jacquard weaving or three-dimensional molding. As will be appreciated, in the event that three-dimensional molding is utilized, the first inflatable chamber 41 may be formed in a plane extending at an intersecting angle to the plane of the second inflatable chamber 42 so as to facilitate mounting and inflation around the intersection between the forward roof rail 30 and the pillar element 32 in a manner to be described further hereinafter. Without regard to the actual construction techniques as may be used, it is considered potentially desirable that any seams resulting from the formation process are formed across a single side of the air bag cushion 40 so as to avoid contact between such seams and the occupant to be protected upon deployment of the air bag cushion 40.

According to a potentially preferred practice, the first inflatable chamber 41 is mounted along the forward pillar element 32 of the vehicle 10 by attachment fixtures such as screws or snap-in elements as will be well know to those of skill in the art. Such attachment fixtures pass through a first set of attachment openings 44 disposed along an interior lateral edge of the first inflatable chamber 41. The second inflatable chamber 42 is preferably secured in place along the forward roof rail 30 by attachment fixtures such as screws or snap-in elements which pass through a second set of attachment openings 45 extending adjacent to the lower edge of the second inflatable chamber 42.

According to the illustrated and potentially preferred embodiment, the air bag cushion 40 includes a downwardly extending perimeter indentation 46 at the intersection between the first inflatable chamber 41 and the second inflatable chamber 42. As shown, the perimeter indentation 46 is preferably of a substantially curved geometry extending from the upper perimeter edge of the air bag cushion 40 and into the interior thereof. As will be appreciated, the presence of the perimeter indentation 46 facilitates the ability to mate the air bag cushion 40 around the intersection between the substantially horizontal forward roof rail 30 and the forward pillar element 32 which extends in angled relation downwardly away from the forward roof rail 30. In order to maintain the air bag cushion 40 at a desired position relative to the intersection between the forward roof rail 30 and the downwardly extending forward pillar element 32, the air bag cushion 40 is provided with a third set of attachment openings 47 disposed at the base of the perimeter indentation 46. As will be appreciated, the substantially pliable nature of the material forming the air bag cushion 40 permits the first inflatable chamber 41 and the second inflatable chamber 42 to extend along intersecting surfaces without closing off fluid communication.

In order to permit efficient storage of the air bag cushion 40 beneath the decorative trim along the forward roof rail 30 and pillar elements 32, it is contemplated that a series of folds will be applied across the surface of the air bag cushion. As illustrated in phantom lines, according to a potentially preferred practice a multiplicity of angled folds 48 may be applied in a substantially fan-like fashion across the first inflatable chamber 41. It is likewise contemplated that a second set of fold lines 49 may be applied in substantially accordion-like fashion across the second inflatable chamber 42. Of course, it is contemplated that other folding and/or rolling compacting techniques as will be well known to those of skill in the art may likewise be utilized to achieve the desired compacted configuration.

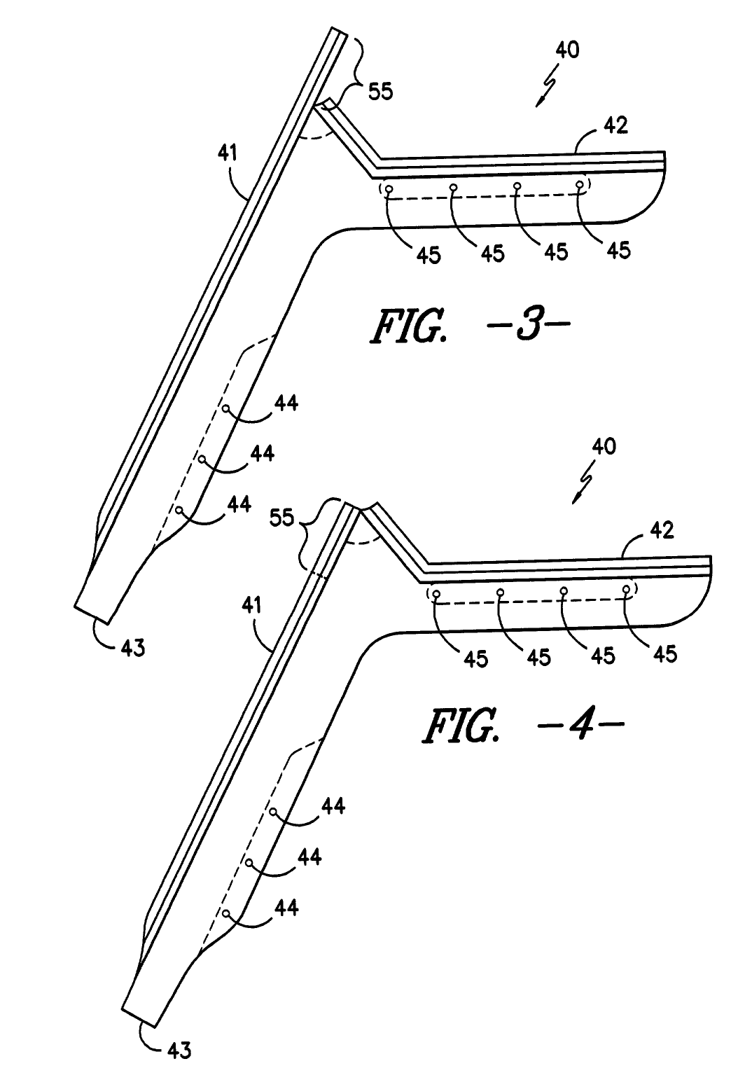

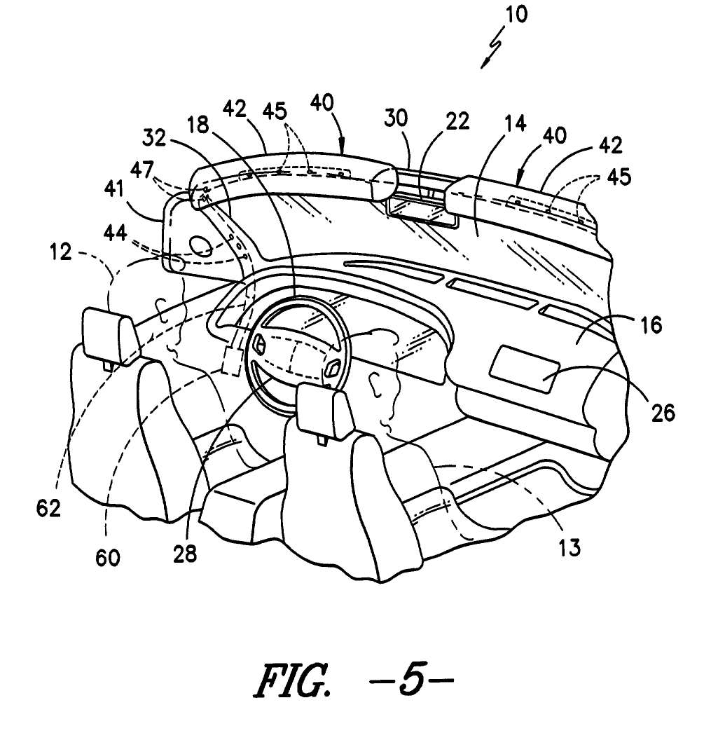

Upon the introduction of folds along the first set of fold lines 48 and the second set of fold lines 49, the resulting folded structure preferably takes on a configuration substantially as illustrated in FIG. 3. In order to cause the folded air bag cushion 40 to correspond substantially with the geometry of the desired storage location extending between the forward roof rail 30 and the forward pillar elements 32, the illustrated outwardly projecting portion 55 of the folded first inflatable chamber 41 may be folded behind the folded structure so as to achieve the configuration substantially as illustrated in FIG. 4. As will be appreciated, this final folded configuration corresponds substantially to the geometry of the structural framework formed by the forward roof rail 30 and forward pillar 32 in surrounding relation to the windshield 14.

Referring to FIG. 5 the inflatable air bag cushion 40 is illustrated in its inflated and operative condition. Referring simultaneously to FIGS. 2-5, in operation a volume of inflation gas is expelled from the inflator 60 and thereafter passes through the hose element 62 and into the mouth opening 43 of the air bag cushion 40. As inflation gas enters the air bag cushion 40, the first inflatable chamber 41 is caused to unfold in substantially the reverse order of the prior folding operation. That is, the outwardly projecting portion 55 is extended followed by the unfolding along the first set of fold lines 48 (FIG. 2). Upon the occurrence of such inflated deployment, the first inflatable chamber projects outwardly in a substantially wedge-like expanded configuration thereby extending away from the position of attachment along the forward pillar element 32 (FIG. 5). Upon such expansion, the first inflatable chamber 41 acts as an impact buffering cushion between the forward pillar element 32 and the opposing vehicle occupant at an early stage of an activating collision event.

Upon the introduction of additional inflation gas, the inflation gas is caused to pass into the second inflatable chamber 42. The introduction of inflation gas into the second inflatable chamber 42 causes the second inflatable chamber 42 to unfold along the second set of fold lines 49 (FIG. 2) in an expansive manner. Such expansion of the second inflatable chamber 42 provides inflated coverage in a substantially bill-like manner extending away from the position of attachment over the forward roof rail 30 and towards the occupant to be protected. As shown, according to a potentially preferred embodiment the second inflatable chamber 42 will preferably extend from the intersection between the forward roof rail 30 and forward pillar element 32 to a position near the center of the windshield 14 such that cooperating inflatable air bag cushions 40 on either side of the vehicle may effect substantial coverage over the length of the forward roof rail 30.

As will be appreciated, any contact between the occupants 12, 13 and the inflatable air bag cushion 40 will be across the interior surface of the air bag cushion 40 facing the occupant to be protected. Thus, in the event that the air bag cushion 40 is constructed according to the preferred practice whereby any seaming takes place substantially entirely across the rear surface of the air bag cushion 40, the occupants 12, 13 will not contact seamed surfaces during deployment of the air bag cushion 40.

It is, of course, to be understood that wide range of alternatives and modifications to the embodiment of the present invention as set forth above may exist. Thus, while the present invention has been illustrated and described in relation to a potentially preferred embodiment, it is to be understood that such embodiment is illustrative only and that the present invention is in no event to be limited thereto. Rather, it is contemplated that modifications and variations embodying the principles of the present invention will no doubt occur to those of skill in the art. It is therefore contemplated and intended that the present invention shall extend to all such modifications and variations as may incorporate the broad principle of the present invention within the full spirit and scope thereof.

1. An inflatable air bag system for use in the cushioning protection of an occupant within a transportation vehicle having a windshield disposed forward of the occupant and a structural framework including an elongate roof rail extending adjacent the upper edge of the windshield and a lateral pillar element extending downwardly away from the roof rail along a lateral side of the windshield, the airbag system comprising:
an inflator for generating inflation gas; and an inflatable air bag cushion in fluid communication with the inflator to receive the inflation gas, wherein the air bag cushion includes a first inflatable chamber disposed in fixed relation along at least a portion of the lateral pillar element and a second inflatable chamber disposed in fixed relation along at least a portion of the roof rail, the first inflatable chamber being in fluid communication with the second inflatable chamber such that upon introduction of the inflation gas into the inflatable air bag cushion, both the first inflatable chamber and the second inflatable chamber are caused to inflate whereby the first inflatable chamber expands between the occupant and at least a portion of the lateral pillar element and whereby the second inflatable chamber expands in covering relation over at least a portion of the roof rail.

2. The invention as recited in claim 1, wherein the first inflatable chamber is of a substantially wedge-shaped geometry.

3. The invention as recited in claim 1, wherein the first inflatable chamber includes a mouth opening for initial receipt of inflation gas from the inflator whereby inflation gas travels through the first inflatable chamber prior to introduction into the second inflatable chamber.

4. The invention as recited in claim 1, wherein the air bag cushion includes a downwardly extending perimeter indentation extending partially across the air bag cushion substantially at the intersection between the first inflatable chamber and the second inflatable chamber, the perimeter indentation being disposed at the intersection between the roof rail and the lateral pillar element.

5. The invention as recited in claim 4, wherein the perimeter indentation is of a substantially arcuate profile.

6. The invention as recited in claim 1, wherein the airbag cushion is formed from a textile fabric.

7. The invention as recited in claim 6, wherein the textile fabric includes a permeability blocking coating.

8. The invention as recited in claim 1, wherein the transportation vehicle is a convertible.

9. An inflatable air bag system for use in the cushioning protection of an occupant within a transportation vehicle having a windshield disposed forward of the occupant and a structural framework including an elongate roof rail extending adjacent the upper edge of the windshield and a lateral pillar element extending downwardly away from the roof rail along a lateral side of the windshield, the airbag system comprising:
an inflator for generating inflation gas; and an inflatable air bag cushion in fluid communication with the inflator to receive the inflation gas, wherein the air bag cushion includes a first inflatable chamber of substantially wedge-shaped geometry including a mouth opening for acceptance of the inflation gas from the inflator, wherein the first inflatable chamber is disposed in fixed relation along at least a portion of the lateral pillar element, the inflatable air bag cushion further including a second inflatable chamber disposed in fixed relation along at least a portion of the roof rail, the first inflatable chamber being in fluid communication with the second inflatable chamber such that upon introduction of the inflation gas into the inflatable air bag cushion, both the first inflatable chamber and the second inflatable chamber are caused to inflate whereby the first inflatable chamber expands between the occupant and at least a portion of the lateral pillar element and whereby the second inflatable chamber expands in covering relation over at least a portion of the roof rail.

10. The invention as recited in claim 9, wherein the first inflatable chamber extends away from the second inflatable chamber towards the mouth opening at a substantially obtuse angle.

11. The invention as recited in claim 10, wherein the mouth opening is disposed substantially at the bottom of the first inflatable chamber.

12. The invention as recited in claim 9, wherein the air bag cushion includes a downwardly extending perimeter indentation extending partially across the air bag cushion substantially at the intersection between the first inflatable chamber and the second inflatable chamber, the perimeter indentation being disposed at the intersection between the roof rail and the lateral pillar element.

13. The invention as recited in claim 12, wherein the perimeter indentation is of a substantially arcuate profile.

14. The invention as recited in claim 9, wherein the air bag cushion is formed from a textile fabric.

15. The invention as recited in claim 14, wherein the textile fabric includes a permeability blocking coating.

16. An inflatable air bag system for use in the cushioning protection of an occupant within a transportation vehicle having a windshield disposed forward of the occupant and a structural framework including an elongate roof rail extending adjacent the upper edge of the windshield and a lateral pillar element extending downwardly away from the roof rail along a lateral side of the windshield, the airbag system comprising:
an inflator for generating inflation gas; and an inflatable air bag cushion in fluid communication with the inflator to receive the inflation gas, wherein the air bag cushion includes a first inflatable chamber and a second inflatable chamber in fluid communication with the first inflatable chamber, the first inflatable chamber being of a substantially wedge-shaped geometry extending at a substantially obtuse angle away from the second inflatable chamber towards a mouth opening for acceptance of the inflation gas from the inflator, the air bag cushion including a downwardly extending perimeter indentation extending partially across the air bag cushion substantially at the intersection between the first inflatable chamber and the second inflatable chamber, the perimeter indentation being disposed at the intersection between the roof rail and the lateral pillar element, the first inflatable chamber being disposed in fixed relation along at least a portion of the lateral pillar element, and the second inflatable chamber being disposed in fixed relation along at least a portion of the roof rail such that upon introduction of the inflation gas into the inflatable air bag cushion, both the first inflatable chamber and the second inflatable chamber are caused to inflate whereby the first inflatable chamber expands between the occupant and at least a portion of the lateral pillar element and whereby the second inflatable chamber expands in covering relation over at least a portion of the roof rail.
